(19) United States
(12) Patent Application Publication
(10) Pub. No.: US 2021/0297573 A1
(43) Pub. Date: Sep. 23, 2021

(54) IMAGING DEVICE, CONTROL METHOD, AND STORAGE MEDIUM

(71) Applicant: CANON KABUSHIKI KAISHA, Tokyo (JP)

(72) Inventor: Tsutomu Utagawa, Tokyo (JP)

(21) Appl. No.: 17/176,573

(22) Filed: Feb. 16, 2021

(30) Foreign Application Priority Data
Mar. 19, 2020 (JP) 2020-049678

(51) Int. Cl. H04N 5/235; H04N 5/247; G02B 5/20; G03B 11/00

(52) U.S. Cl. CPC H04N 5/2351; H04N 5/247; G03B 11/00; G02B 5/208; H04N 5/2354

(57) ABSTRACT

An imaging device includes a first imaging unit that has a first infrared cut filter and can change an imaging area, a second imaging unit that has a second infrared cut filter, an insertion/removal unit that inserts or removes the first infrared cut filter and the second infrared cut filter into or from each of optical paths of the first imaging unit and the second imaging unit, and a control unit that controls insertion or removal of the first infrared cut filter of the first imaging unit based on image information of the second imaging unit if the imaging area of the first imaging unit is changed so as to overlap with an imaging area that the second imaging unit is capturing or changed to an area close to the imaging area that the second imaging unit is capturing.

### BACKGROUND OF THE INVENTION

### Field of the Invention

The present invention relates to an imaging device, a control method, and a storage medium.

### Description of the Related Art

Imaging devices (multi-lens cameras) having a plurality of imaging units that are movable in one monitoring device and can move each of the imaging units to follow a plurality of monitoring targets have recently become known as monitoring cameras. Among such multi-lens cameras, an imaging device having a plurality of imaging units that are disposed on a circular rail around the imaging device to be movable on the rail is known. Furthermore, an imaging device mounted a pan-tilt-zoom camera (which will be referred to as a “PTZ camera” below) that can change an imaging direction in horizontal and vertical directions in a wide range and can change a zoom magnification, in a multi-lens camera, is also known.

Normally, imaging devices employ a method of switching between an imaging mode in a case in which sufficient brightness is obtained like in daytime (which will be referred to as a “day mode” below) and another imaging mode in a case in which sufficient brightness is not obtained like at night (which will be referred to as a “night mode” below) in accordance with an average luminance of camera images. Switching between the day mode and the night mode is generally performed when there is no change in a certain time period after a change from brightness to darkness or darkness to brightness in consideration of hysteresis. For this reason, there is a case in which a PTZ camera does not perform switching between the day mode and the night mode immediately after an imaging area is changed and does not capture an optimum video for a certain period of time. In order to solve this problem, Japanese Patent Application No. 4438065 has proposed a method of a PTZ camera to record an imaging mode (a color imaging mode or a black-and-white imaging mode) at each imaging position together with time information and to change the imaging mode when the imaging position is changed.

However, the disclosed related art described above may not be able to handle to an irregular occasion such as a case in which an illumination device breaks down in an area in which the illumination device would normally maintain sufficient brightness even at night.

### SUMMARY OF THE INVENTION

The present invention provides an imaging device that can control a day mode and a night mode in which brightness in an imaging area is reflected in real time.

An imaging device according to an embodiment of the present invention includes a first imaging unit that has a first infrared cut filter and configured to change an imaging area, a second imaging unit that has a second infrared cut filter, an insertion/removal unit configured to insert or remove the first infrared cut filter and the second infrared cut filter into or from each of optical paths of the first imaging unit and the second imaging unit, and a control unit configured to control insertion or removal of the first infrared cut filter based on image information of the second imaging unit in a case where the imaging area of the first imaging unit is changed so as to overlap with an imaging area that the second imaging unit is capturing or changed to an area close to the imaging area that the second imaging unit is capturing from a state in which the imaging area of the first imaging unit does not overlap the imaging area of the second imaging unit.

Further features of the present invention will become apparent from the following description of exemplary embodiments with reference to the attached drawings.

### BRIEF DESCRIPTION OF THE DRAWINGS

FIG. 1 is a block diagram of an imaging system including an imaging device according to a first embodiment.

FIGS. 2A and 2B are exterior views of the imaging device.

FIG. 3 is a diagram illustrating an example of a state in which an illumination unit is turned on.

FIG. 4 is a flowchart for describing an operation of switching between a day mode and a night mode of cameras 1100 to 1300.

FIGS. 5A and 5B are diagrams illustrating an example of a state in which videos are displayed on a display device according to the first embodiment.

FIG. 6 is a diagram illustrating an example of a state after an imaging direction of a camera 1400 according to the first embodiment is changed.

FIG. 7 is a flowchart for describing an operation of switching between a day mode and a night mode of the camera 1400 according to the first embodiment.

FIGS. 8A and 8B are diagrams illustrating an example of a state in which videos are displayed on a display device according to a second embodiment.

FIG. 9 is a diagram illustrating an example of a state after a camera 1400 according to the second embodiment changes an imaging direction.

FIG. 10 is a diagram in which only a video captured by a camera 1100 of FIG. 8 is extracted.

FIG. 11 is a flowchart for describing an operation of switching between a day mode and a night mode of the camera 1400 according to the second embodiment.

FIG. 12 is a diagram illustrating an example of a state in which videos are displayed on a display device according to a third embodiment.

### DESCRIPTION OF THE EMBODIMENTS

Next, embodiments of the present invention will be described using the drawings. The same reference numerals will be given to constituent elements having the same functions in the drawings, and repetitive description thereof will be omitted. In addition, configurations introduced in the embodiments below are merely examples, and the present invention is not limited to the illustrated configurations.

### First Embodiment

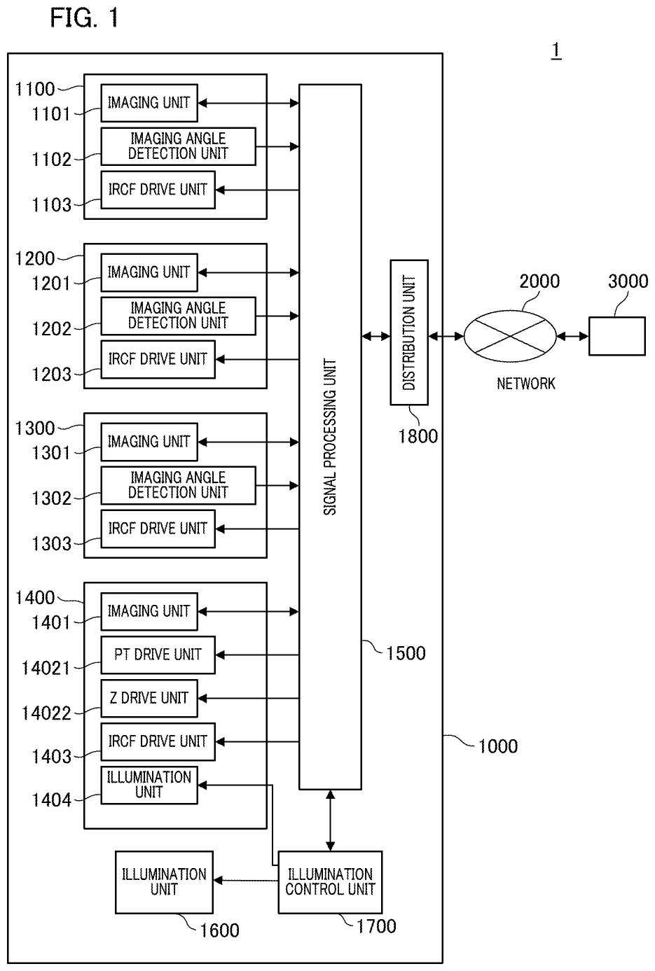

FIG. 1 is a block diagram of an imaging system including an imaging device according to a first embodiment. The imaging system 1 includes the imaging device 1000 and a client device 3000 (information processing device). The client device 3000 includes a CPU and a memory, and the CPU comprehensively controls each constituent element of the client device 3000 according to a computer program loaded from the memory, and for example, sets various parameters. The client device 3000 has an input unit such as a mouse and a keyboard and a specifying unit configured to specify imaging areas of cameras 1100 to 1400 which will be described below. An operator of the imaging device 1000 uses the input unit to specify imaging areas of the cameras 1100 to 1400 and thus can change the imaging areas of the cameras 1100 to 1400. The client device 3000 is connected to the imaging device 1000 via a network 2000 to be communicable with each other.

The network 2000 is a local area network (LAN) on a network and may be configured by a router satisfying a communication standard such as Ethernet (trademark).

The imaging device 1000 has the camera 1100, the camera 1200, the camera 1300, the camera 1400, a signal processing unit 1500, an illumination unit 1600, an illumination control unit 1700, and a distribution unit 1800. As an example in the present embodiment, the camera 1100, the camera 1200, and the camera 1300 are cameras with the same configuration, and the camera 1400 has a different configuration from the other three cameras 1100 to 1300.

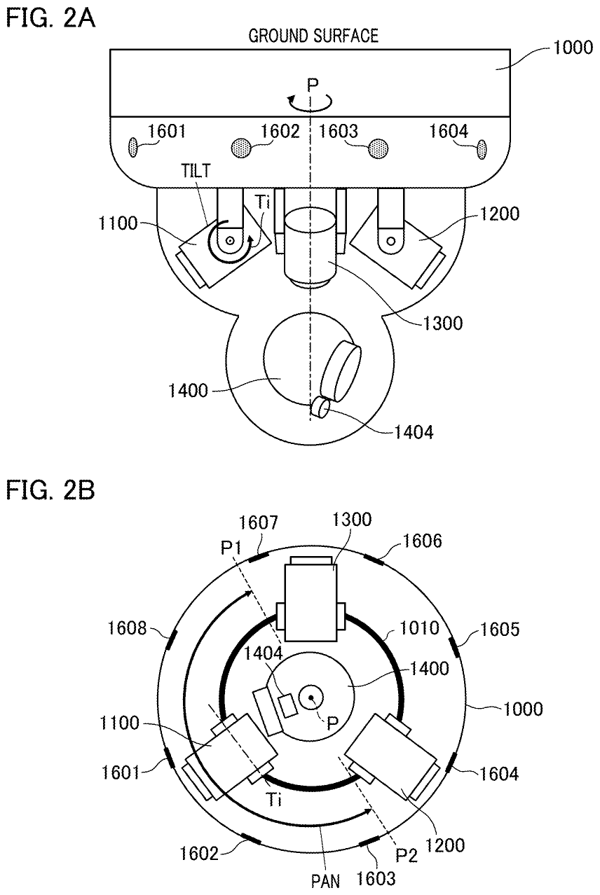

FIGS. 2A and 2B illustrate exterior views of the imaging device 1000. FIG. 2A is a horizontal view of the imaging device 1000 in an installed state, and FIG. 2B is a view of the imaging device 1000 in the installed state from below. Although the exterior of the imaging device 1000 is not actually transparent, it is depicted as being transparent here in order to make it easier to understand the positional relationship of the cameras 1100 to 1400.

The cameras 1100 to 1300 can change imaging angles of view by changing each of pan angles and tilt angles. A pan angle can be changed by moving the cameras 1100 to 1300 on a circular rail 1010 (guide unit) as illustrated in FIG. 2B. A pan angle can be changed until a camera reaches an adjacent camera. In a case in which a pan angle of the camera 1100 is desired to be adjusted when the cameras 1100 to 1300 are disposed as illustrated in FIG. 2B, for example, the camera 1100 can be moved in the range from P1 to P2 in the drawing around an axis P. Further, although the cameras 1100 to 1300 are manually moved by a user in the present embodiment, the cameras may be automatically moved with a drive system mounted therein.

A tilt angle can be changed around an axis Ti as illustrated in FIG. 2A.

A rotary encoder, a photo interrupter, an angular velocity sensor, and the like are mounted in the cameras 1100 to 1300, and pan angles and tilt angles of the cameras 1100 to 1300 are detected by imaging angle detection units 1102 to 1302. The detected pan angles and tilt angles of the cameras 1100 to 1300 are converted into electric signals and transmitted to the signal processing unit 1500. That is, the signal processing unit 1500 can ascertain imaging areas of the cameras 1100 to 1300. Further, in the present specification, the concept of an imaging area includes an imaging direction (pan and tilt direction) and a zoom position in the imaging direction. Further, the zoom position is determined according to a zoom magnification.

The camera 1400 can change a pan angle and a tilt angle via a PT drive unit 14021 according to a control signal output from the signal processing unit 1500 in a remote operation of a drive system, which is not illustrated. Furthermore, a zoom magnification can be changed via a Z drive unit 14022 in a remote operation of the drive system, which is not illustrated. That is, the camera 1400 can change an imaging area. A pan angle of the camera 1400 can be changed in a range of 350 degrees around a pan axis, and a tilt angle thereof can be changed in a range of 200 degrees around a tilt axis passing through the center of the camera 1400 in a horizontal direction.

Each of the imaging units 1101 to 1401 of the cameras includes a lens and a solid state image sensor such as a charge coupled device (CCD) image sensor or a complementary MOS (CMOS) image sensor. The imaging unit 1101 to the imaging unit 1401 convert light incident from the lenses into electric signals using the solid state image sensors. In the present embodiment, as an example, the solid state image sensors that convert video into electric signals with 1920×1080 pixels and a frame rate of 60 FPS are mounted in each of the cameras, and the video signals that have been converted into the electric signals are transmitted to the signal processing unit 1500.

In addition, a horizontal angle of view of the cameras 1100 to 1300 is 80 degrees and a vertical angle of view thereof is 45 degrees, and a horizontal angle of view of the camera 1400 is 56 to 20 degrees and a vertical angle of view thereof is 31.5 to 11.3 degrees.

Pixels in each solid state image sensor have on-chip color filters in an RGB Bayer array, and are configured to acquire luminance information as well as color information.

In each of the cameras 1100 to 1400, an infrared cut filter (IRCF), which is not illustrated, is disposed in front of the solid state image sensor of each camera so that it is perpendicular to the optical axis and can be inserted into and removed from the optical path. The IRCF does not transmit but reflects infrared components and transmits visual light. The IRCF of each camera is switched to be inserted and removed via IRCF drive units 1103 to 1403 based on a control signal output from the signal processing unit 1500. The IRCF drive units 1103 to 1403 individually insert or remove the IRCFs into or from the optical paths of the cameras 1100 to 1400, respectively.

Hereinafter, an imaging mode in which an IRCF is inserted into the optical path will be referred to as a day mode, and an imaging mode in which an IRCF is removed from the optical path will be referred to as a night mode.

In the day mode, light incident on pixels in the solid state image sensor is limited only to visual light because the IRCF is inserted into the optical path. Thus, an SN ratio of pixel signals is lower than in the night mode in which the IRCF is removed from the optical path. That is, the quality of luminance information deteriorates. On the other hand, the quality of color information improves because infrared light is not incident on the pixels of the solid state image sensor. Meanwhile, in the night mode, while the quality of luminance information improves, the quality of color information deteriorates because both visual light and infrared light are incident on the pixels of the solid state image sensor.

The imaging modes are used differently in general as will be described below in consideration of the above-described tradeoff. In a case in which illuminance of a subject is sufficiently high, that is, in a case in which an imaging area is bright, sufficiently high-quality luminance information is obtained only with visual light, and thus imaging is performed in the day mode with quality of color information emphasized. On the other hand, in a case in which illuminance of a subject is low and high-quality luminance information is not obtained only with visual light, that is, in a case in which an imaging area is dark, imaging is performed in the night mode. Further, because the quality of color information deteriorates due to mixing of infrared light in the night mode as described above, only luminance information is used. In other words, pixel signals are treated as a monochrome image in the night mode. As a result, a video distributed via the distribution unit 1800, which will be described below, becomes a color image in the day mode and a black-and-white image in the night mode.

The signal processing unit 1500 transmits set values for imaging conditions to each imaging unit of the cameras 1100 to 1400 and changes drive states of the imaging units 1101 to 1401 of the cameras. Here, the imaging conditions include a gain condition, a dynamic range condition, an exposure condition, a focus condition, and the like.

In addition, the signal processing unit 1500 receives angle information of each camera output from the imaging angle detection units 1102 to 1302 to calculate an imaging area of each camera. In addition, because the signal processing unit 1500 controls imaging areas of the camera 1400, the signal processing unit 1500 can ascertain the imaging areas of the camera 1400.

Furthermore, the signal processing unit 1500 receives electric signals output from the imaging units 1101 to 1401 of the cameras 1100 to 1400, performs predetermined image processing thereon, and generates video data in a predetermined format. The generated video data is distributed as video information via the distribution unit 1800 on the network 2000.

In addition, the signal processing unit 1500 converts RGB signals that are electric signals output from the imaging units 1101 to 1401 into YCbCr signals and extracts luminance information Y. The signal processing unit 1500 uses the luminance information to switch between the day mode and the night mode. In other words, the signal processing unit 1500 controls insertion or removal of the IRCFs. For example, if a state of an average luminance value of a one-frame image captured by the imaging unit 1101 being higher than a threshold value A continues for a predetermined time period, for example, three seconds, the signal processing unit 1500 determines that the day mode is to be used in consideration of hysteresis. Conversely, if a state of an average luminance value being lower than a threshold value B continues for the predetermined time of period, it is determined that the night mode is to be used. The signal processing unit 1500 makes the determination of the day mode/night mode for each camera, and outputs, to the camera, a signal for controlling insertion or removal of the IRCF via the IRCF drive unit according to the result of the determination of the day mode/night mode.

Furthermore, an illumination unit 1600 and another illumination unit 1404 are also mounted in the imaging device 1000 as illustrated in FIG. 1. The illumination unit 1600 and the illumination unit 1404 are controlled such that the units are turned on based on a control signal output from the signal processing unit 1500.

The illumination unit 1600 includes light emitting elements such as a plurality of light emitting diodes (LEDs). Eight LEDs 1601 to 1608 are disposed around the imaging device 1000 at equal intervals as illustrated in FIGS. 2A and 2B as an example. The LEDs 1601 to 1608 can be said to be disposed at positions corresponding to imaging directions in which the cameras 1100 to 1300 can perform imaging. The signal processing unit 1500 performs control with the illumination control unit 1700 such that the LEDs 1601 to 1608 are turned on in accordance with the illuminance of the subject that the cameras 1100 to 1300 are imaging.

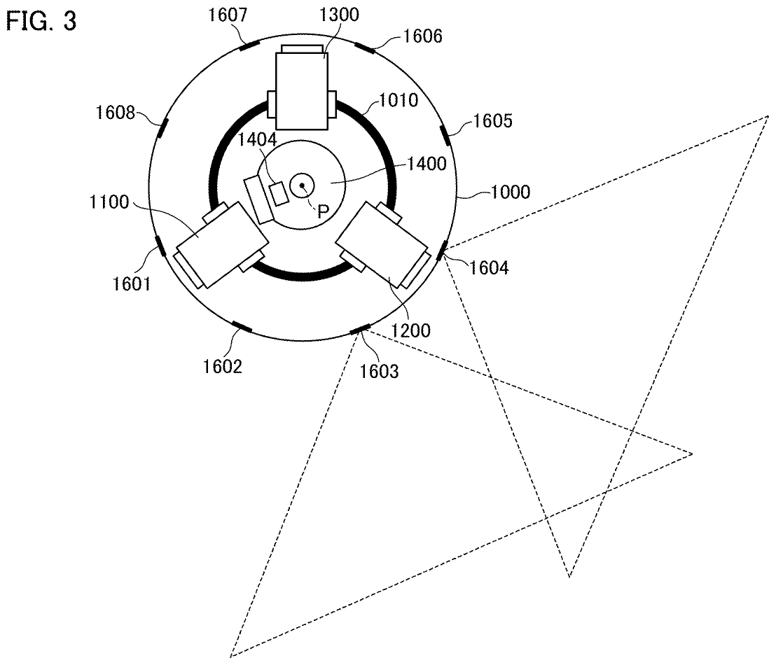

FIG. 3 is a diagram illustrating an example of a state in which the illumination unit 1600 is turned on. FIG. 3 is a diagram illustrating a state in which the LEDs 1601 to 1608 are turned on when the camera 1200 performs imaging in the night mode because an average luminance value of the imaging area of the camera 1200 is low and performs imaging in the day mode because an average luminance value of the imaging areas of the cameras 1100 and 1300 is high. In the drawing, the signal processing unit 1500 outputs a control signal to turn on only the LEDs 1603 and 1604 that can illuminate the imaging direction of the camera 1200 detected by the imaging angle detection unit 1102 and to turn off the remaining LEDs 1601, 1602, and 1605 to 1608. In other words, the signal processing unit 1500 performs control such that the LEDs 1603 and 1604 disposed at the positions corresponding to the imaging direction of the camera 1200 are turned on.

Separate from the illumination unit 1600, for example, an LED is mounted in the camera 1400 as the illumination unit 1404 that illuminates the same direction as that of the optical axis of the imaging unit 1401. The signal processing unit 1500 controls illumination of the illumination unit 1404 as well as the illumination unit 1600 using the illumination control unit 1700.

Here, a specific control method of the illumination units 1600 and 1404 will be described. The signal processing unit 1500 determines brightness/darkness of the imaging area for each camera based on an average luminance value similarly to the determination of the day mode/night mode, and when the average luminance value is lower than a predetermined threshold value, the signal processing unit outputs a control signal to turn on an LED that illuminates the imaging direction of each of the cameras 1100 to 1400. Further, control may be performed such that the illumination units 1600 and 1404 are turned on based on information of whether each of the cameras 1100 to 1400 is in the day mode or the night mode, in other words, information of a state in which the IRCF of each of the cameras 1100 to 1400 has been inserted or removed.

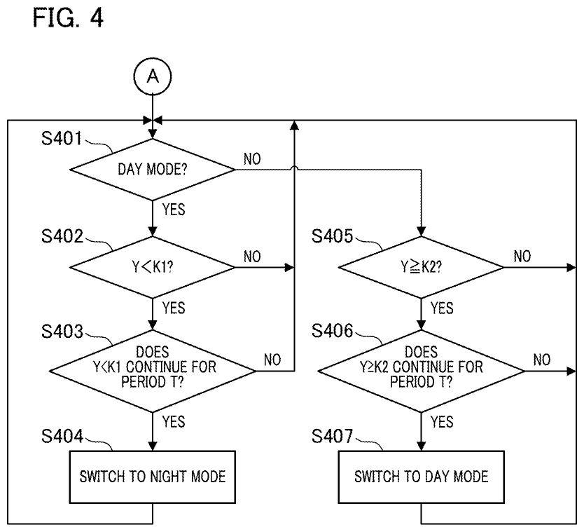

Next, an operation of switching between the day mode and the night mode will be described using a flowchart. FIG. 4 is a flowchart for describing an operation of switching between the day mode and the night mode of the cameras 1100 to 1300. Each operation (step) shown in this flowchart can be executed by the signal processing unit 1500. Although the cameras 1100 to 1300 are independent from each other, they operate in the same sequence to perform switching between the day mode and the night mode, and thus the operation of the camera 1100 will be described here as a representative example.

When power of the imaging device 1000 is on, the camera 1100 starts the operation of switching between the day mode and the night mode after a predetermined initialization process ends. First, the signal processing unit 1500 checks whether the IRCF, which is not illustrated, has been inserted into the optical path of the camera 1100 to determine whether the current state of the camera 1100 is the day mode or the night mode (step 401, which will be abbreviated as S401). If the state is determined to be the day mode (Yes), the signal processing unit 1500 calculates an average luminance value Yn of a one-frame video captured by the imaging unit 1101 of the camera 1100 and compares the average luminance with a threshold value K1 at which the day mode is switched to the night mode (S402). If the average luminance value Yn is equal to or higher than the threshold value K1 (No), that is, the video of the camera 1100 is bright enough to have a luminance equal to or higher than a predetermined value, the process returns to S401.

On the other hand, if the average luminance value Yn is smaller than the threshold value K1 (Yes), the signal processing unit 1500 compares the threshold value K1 with an average luminance value Yn+1 of the next frame, and if the average luminance value Yn+1 is equal to or higher than the threshold value K1, the process returns to S401. If the average luminance value Yn+1 is smaller than the threshold value K1, a comparison of an average luminance value Yn+2 of the next frame with the threshold value K1 continues (S403), and if a state of the average luminance value Y being smaller than the threshold value K1 continues for a predetermined time period T, for example, three seconds (Yes), the mode is switched to the night mode (S404). In other words, the LED in the direction in which the camera 1100 is imaging is turned on as the IRCF is removed from the optical path of the camera 1100, and the process returns to S401.

If the state is determined to be the night mode in S401, the signal processing unit 1500 calculates an average luminance value Yn of a one-frame video captured by the imaging unit 1101 of the camera 1100 and compares the average luminance value with a threshold value K2 at which the night mode is switched to the day mode (S405). If the average luminance value Yn is smaller than the threshold value K2 (No), that is, the video of the camera 1100 is dark enough to have a value smaller than a predetermined value, the process returns to S401. If the average luminance value Yn is equal to or higher than the threshold value K2 (Yes), an average luminance value Yn+1 of the next frame is compared with the threshold value K2, and if the average luminance value Yn+1 is smaller than the threshold value K2, the process returns to S401. If the average luminance value Yn+1 is equal to or higher than the threshold value K2, a comparison of an average luminance value Yn+2 of the next frame with the threshold value K2 continues (S406), and if a state of the average luminance value Y being equal to or higher than the threshold value K2 continues for a predetermined time period T, for example, three seconds (Yes), the mode is switched to the night mode (S407). In other words, the LED in the direction in which the camera 1100 is imaging is turned off as the IRCF is inserted into the optical path of the imaging unit 1101, and the process returns to S401. The operations from S401 to S407 are repeated thereafter.

Here, the method of calculating the average luminance value of a one-frame video in S402, S403, S405, and S406 has been described. However, it is not necessary to use the average of the total number of pixels 1920×1080 of the camera 1100, and for example, the average of the total number of pixels 384×216 obtained by thinning out every five pixels may be used for an average luminance value. In addition, although the method of comparing the average luminance values with the threshold values for each frame has been described in S403 and S406, the comparison of an average luminance value with a threshold value may be performed for every fifth frame after thinning out.

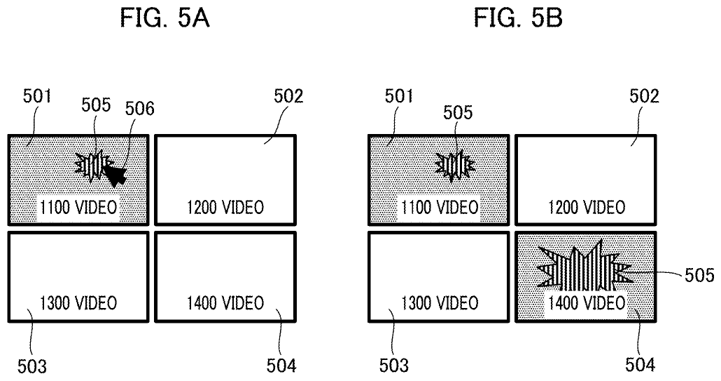

Next, an operation of switching between the day mode and the night mode of the camera 1400 that can change a camera imaging direction will be described using FIGS. 5A, 5B, 6, and 7. In the present embodiment, the signal processing unit 1500 controls insertion or removal of the IRCF of the camera 1400 based on image information of the entire imaging area of any of the cameras 1100 to 1300. Further, the image information here includes, for example, luminance information and color information. Because luminance information is preferably used as image information, an example in which luminance information is used will be described here, however, color information may be used. In addition, both luminance information and color information may be used.

A video captured by the imaging device 1000 is transmitted to, for example, the client device 3000 serving as an external apparatus such as a PC via the network 2000 and displayed on a display device such as a monitor. FIGS. 5A and 5B are diagrams illustrating an example of a state in which videos are displayed on a display device according to the first embodiment. Videos 501 to 504 are captured by the cameras 1100 to 1400, respectively. Here, as an example, the camera 1100 has performed imaging in the night mode because the imaging direction was dark, and a black-and-white image is displayed. The cameras 1200 to 1400 have performed imaging in the day mode because the imaging directions were bright, and display is performed in the color mode.

FIG. 5A is a diagram illustrating an example of a state in which videos are displayed on a display device before the imaging direction of the camera 1400 is changed. In FIG. 5A, it is assumed that, in an area of interest 505, for example, an event that requires checking in a detailed video has been captured. In the present specification, such an area that a user wants to check in a detailed video will be referred to as an area of interest. An operator operating the imaging device 1000 clicks the area of interest 505 using, for example, a pointer 506 operated with a mouse of the client device 3000 to specify an area and gives an instruction to change the imaging direction. Then, the coordinates of the clicked area in the captured image are transmitted to the signal processing unit 1500 via the network 2000. Next, the signal processing unit 1500 calculates an imaging direction of the camera 1400 specified by the operator. Specifically, the imaging direction of the camera 1400 specified by the operator is calculated based on the pan angle and the tilt angle of the camera 1100 ascertained by the signal processing unit 1500 in advance based on a signal output from the imaging angle detection unit 1102 of the camera 1100 and the coordinates of the clicked area. Next, the signal processing unit 1500 outputs a control signal to the PT drive unit 14021 to make the camera 1400 face in the calculated imaging direction, the camera 1400 is caused to face in the clicked direction, and thereby the imaging direction of the camera 1400 is changed. That is, the area specified by the operator can be said to be an imaging area after the imaging direction of the camera 1400 is changed.

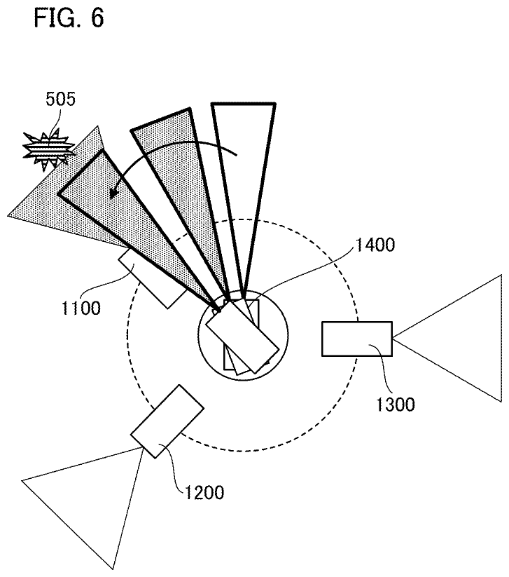

FIG. 6 is a diagram illustrating an example of a state after an imaging direction of the camera 1400 according to the first embodiment is changed. This drawing illustrates a state in which the camera 1400 has changed the direction to the direction of the area of interest 505 to capture the area of interest 505. As illustrated in FIG. 6, the camera 1400 that has performed imaging in the day mode switches to the night mode that is the imaging mode of the camera 1100 imaging the area of interest 505 while moving. That is, the signal processing unit 1500 starts control of insertion or removal until at least the change of the imaging direction of the camera 1400 ends. By performing control as described above, when the change of the imaging direction is completed, the camera 1400 is in the mode suitable for the brightness of the imaging area after the change. Thus, a time required for switching between the day mode and the night mode can be reduced, and loss of opportunities to capture a desired video can be avoided.

Returning to FIG. 5, FIG. 5B is a diagram illustrating an example of a state in which videos are displayed on the display device after the imaging direction of the camera 1400 is changed. The drawing illustrates a state in which imaging is being performed in the night mode immediately after the camera 1400 facing in the direction of the clicked area of interest 505 has changed in the direction of the area of interest 505.

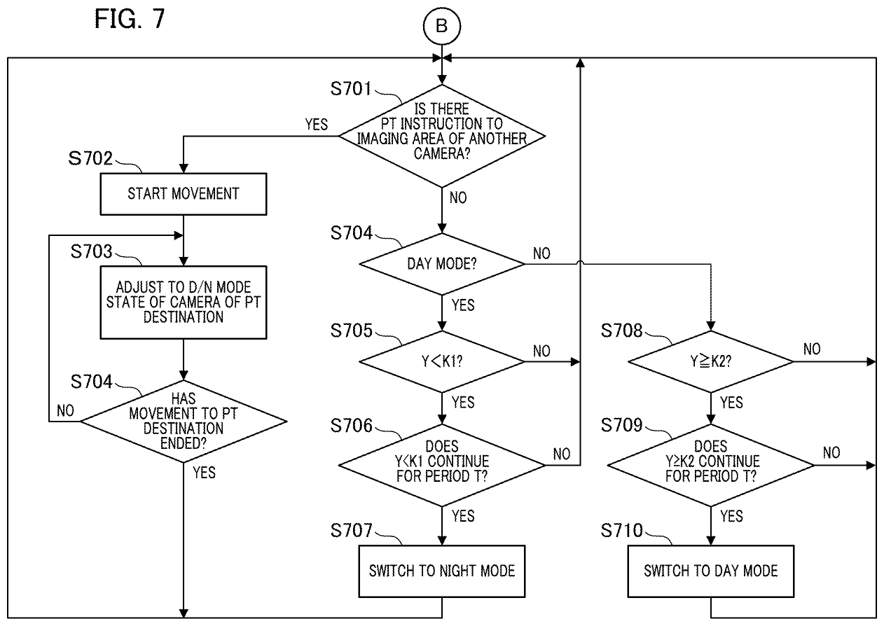

Next, an operation of switching between the day mode and the night mode of the camera 1400 that can change an imaging direction will be described using the flowchart of FIG. 7. FIG. 7 is a flowchart for describing an operation of switching between the day mode and the night mode of the camera 1400 according to the first embodiment. Each operation (step) shown in this flowchart can be executed by the signal processing unit 1500. When power of the imaging device 1000 is on, the camera 1400 starts the operation of switching between the day mode and the night mode after a predetermined initialization process ends. First, the signal processing unit 1500 checks whether there is an instruction from an operator to change a pan angle and a tile angle of the camera 1400 to change the direction to the direction in which the remaining cameras 1100 to 1300 are performing imaging (S701). In other words, the signal processing unit 1500 checks whether there is an instruction to the camera 1400 from the operator to change the imaging area to an area overlapping the imaging area of the other cameras 1100 to 1300. If there is the instruction from the operator to change the direction to the area that the other cameras 1100 to 1300 are performing imaging (Yes), a change of the direction of the camera 1400 is started via the PT drive unit 14021 so that the camera 1400 faces the instructed direction (S702).

Next, the signal processing unit 1500 changes the imaging mode of the camera 1400 in accordance with the other cameras instructed by the operator, in other words, the day mode or the night mode of the cameras imaging the area of interest 505 (S703). That is, the signal processing unit 1500 controls the insertion or removal of the IRCF of the camera 1400 based on information on the insertion/removal stage of the IRCFs of the other cameras instructed by the operator. Next, the signal processing unit 1500 determines whether the change of the camera direction of the camera 1400 to the instructed direction has been completed (S704), and if the change of the direction is not completed (No), the process returns to S703, and if the change of the direction is completed (Yes), the process returns to S701.

On the other hand, if there is no instruction of changing the direction to the area that the other cameras 1100 to 1300 are imaging in S701 (No), the signal processing unit 1500 determines whether the current state of the camera 1400 is the day mode or the night mode (S704). If the state is determined to be in the day mode (Yes), the signal processing unit 1500 calculates an average luminance value Yn of a one-frame video captured by the imaging unit 1401 of the camera 1400 and compares the average luminance value with the threshold value K1 at which the day mode is switched to the night mode (S705). If the average luminance value Yn is equal to or higher than the threshold value K1 (No), that is, the video of the camera 1400 is bright enough to have a value equal to or higher than a predetermined value, the process returns to S701. If the average luminance value Yn is smaller than the threshold value K1, an average luminance value Yn+1 of the next frame is compared with the threshold value K1, and if the average luminance value Yn+1 is equal to or higher than the threshold value K1, the process returns to S701. If the average luminance value Yn+1 is smaller than the threshold value K1, a comparison of an average luminance value Yn+2 of the next frame with the threshold value K1 continues, and if a state of the average luminance value Y being smaller than the threshold value K1 continues for a predetermined time period T, for example, three seconds (Yes in S706), the mode is switched to the night mode (S707). In other words, the illumination unit 1404 is turned on as the IRCF is removed from the optical path of the camera 1400, and the process returns to S701.

If the state is determined to be in the night mode in S704 (No), the signal processing unit 1500 calculates an average luminance value Yn of a one-frame video captured by the imaging unit 1401 of the camera 1400 and compares the average luminance value with the threshold value K2 at which the night mode is switched to the day mode (S708). If the average luminance value Yn is smaller than the threshold value K2 (No), that is, the video of the camera 1400 is dark enough to have a value smaller than a predetermined value, the process returns to S701. If the average luminance value Yn is equal to or higher than the threshold value K2 (Yes), an average luminance value Yn+1 of the next frame is compared with the threshold value K2, and if the average luminance value Yn+1 is smaller than the threshold value K2, the process returns to S701. If the average luminance value Yn+1 is equal to or higher than the threshold value K2, a comparison of an average luminance value Yn+2 of the next frame with the threshold value K2 continues (S709), and if a state of the average luminance value Y being equal to or higher than the threshold value K2 continues for a predetermined time period T, for example, three seconds (Yes), the mode is switched to the day mode (S710). In other words, the illumination unit 1404 is turned off as the IRCF is inserted into the optical path of the imaging unit 1401, and the process returns to S701. The operations from S701 to S710 are repeated thereafter.

Here, the method of calculating the average luminance value of a one-frame video in S704, S705, S708, and S709 has been described. However, it is not necessary to use the average of the number of entire pixels 1920×1080 of the camera 1400, and for example, the average of the number of pixels 384×216 obtained by thinning out every five pixels may be used for an average luminance value. In addition, although the method of comparing the average luminance values with the threshold values for each frame has been described in S706 and S709, the comparison of an average luminance value with a threshold value may be performed for every fifth frame after thinning out.

According to the present embodiment, control of the day mode or the night mode can be performed reflecting brightness in an imaging area in real time.

### Second Embodiment

In the first embodiment, a method of matching the imaging mode of the camera 1400 with an imaging mode of a camera imaging an area specified by an operator has been described. However, an imaging area of the camera 1400 may be narrower than an imaging area of the other cameras 1100 to 1300. In this case, an optimum image may not be obtained only by matching the mode to the imaging mode of the camera for a specified area.

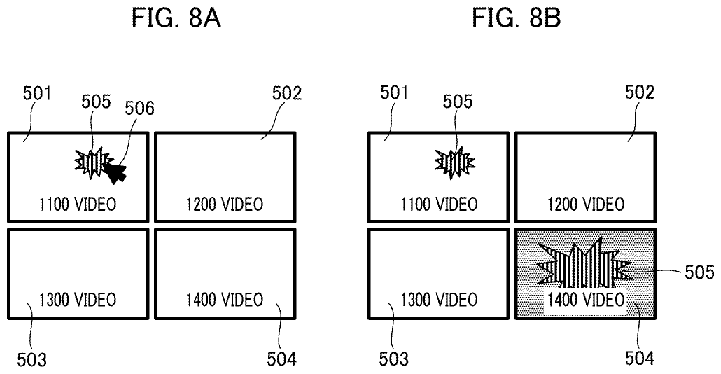

FIGS. 8A and 8B are diagrams illustrating an example of a state in which videos are displayed on a display device according to a second embodiment. In FIGS. 8A and 8B, videos 501 to 504 captured by the cameras 1100 to 1400, respectively are illustrated, as in FIGS. 5A and 5B. FIG. 8A is a diagram illustrating an example of a state in which videos are displayed on the display device before the imaging direction of the camera 1400 is changed. The cameras 1100 to 1400 are all performing imaging in the day mode because the imaging areas thereof are bright, and the images are displayed in the color mode. In FIG. 8A, when the area of interest 505 is clicked using the pointer 506 operated with the mouse of the client device 3000, for example, the camera 1400 faces the clicked direction.

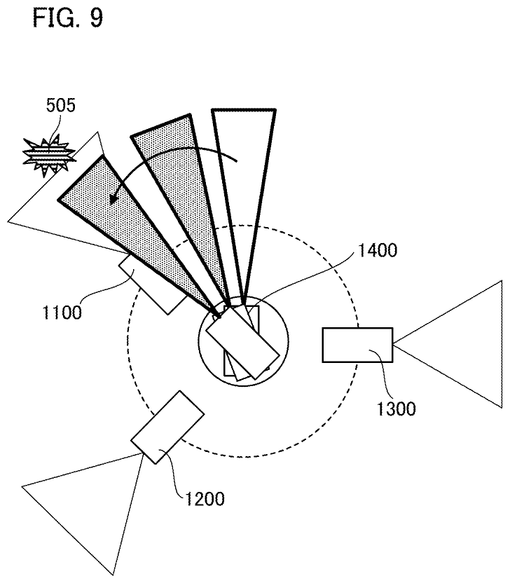

FIG. 9 is a diagram illustrating an example of a state after an imaging direction of the camera 1400 according to the second embodiment is changed. This drawing illustrates a state in which the camera 1400 has changed the direction to the direction of the area of interest 505 to capture the area of interest 505. FIG. 9 illustrates that, although the camera 1400 has performed imaging in the day mode, the camera switches to the night mode while moving in accordance with brightness of the area of interest 505. That is, the signal processing unit 1500 starts the control of insertion or removal until at least the change of the imaging direction of the camera 1400 ends.

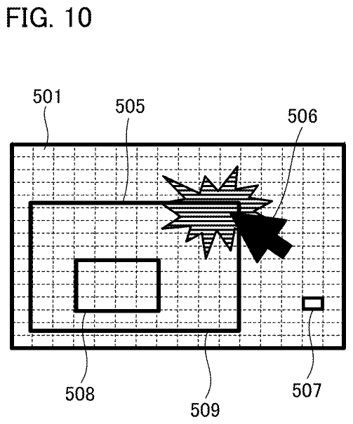

Returning to FIG. 8, FIG. 8B is a diagram illustrating an example of a state in which videos are displayed on the display device after the imaging area of the camera 1400 is changed. The drawing illustrates a state in which the camera 1400 facing in the direction of the clicked area of interest 505 is performing imaging in the night mode in accordance with brightness of the area of interest immediately after the camera changes the direction to the direction of the area of interest 505. In the first embodiment, the method of referring to the imaging mode of the other cameras instructed by the operator for switching between the day mode and the night mode of the camera 1400 in S703 has been described. In the second embodiment, a method of changing an area with a luminance value to be referred to according to an angle of view of the camera 1400 will be described. FIG. 10 is a diagram in which only the video 501 captured by a camera 1100 of FIG. 8 is extracted. The video captured by the camera 1100 is divided into 16 pieces in the horizontal direction and the vertical direction, respectively, resulting in a total of 256 small areas, as illustrated in FIG. 10. An area 507 represents one of the small areas. The signal processing unit 1500 records an average luminance value Y of each small area for the last three seconds. That is, a moving average value of luminance values of the small areas for three seconds is recorded while updating a frame rate with 60 Hz.

In FIG. 10, an area 508 represents an imaging area at a minimum zoom magnification of the camera 1400, and an area 509 represents an imaging area at a maximum zoom magnification thereof. When the camera 1400 faces an area specified by an operator, the signal processing unit 1500 extracts a group of small areas around the specified position (area) to be captured by the camera 1400 after the change of the direction with a current zoom magnification. Specifically, for example, a position on a captured image is specified with the pointer 506 operated by the operator. Then, a group of small areas around the position specified with the pointer 506 is extracted in accordance with the current zoom magnification. Next, the average luminance value of the extracted group of small areas for the last three seconds is compared with a predetermined threshold value, and the imaging mode of the camera 1400 is switched.

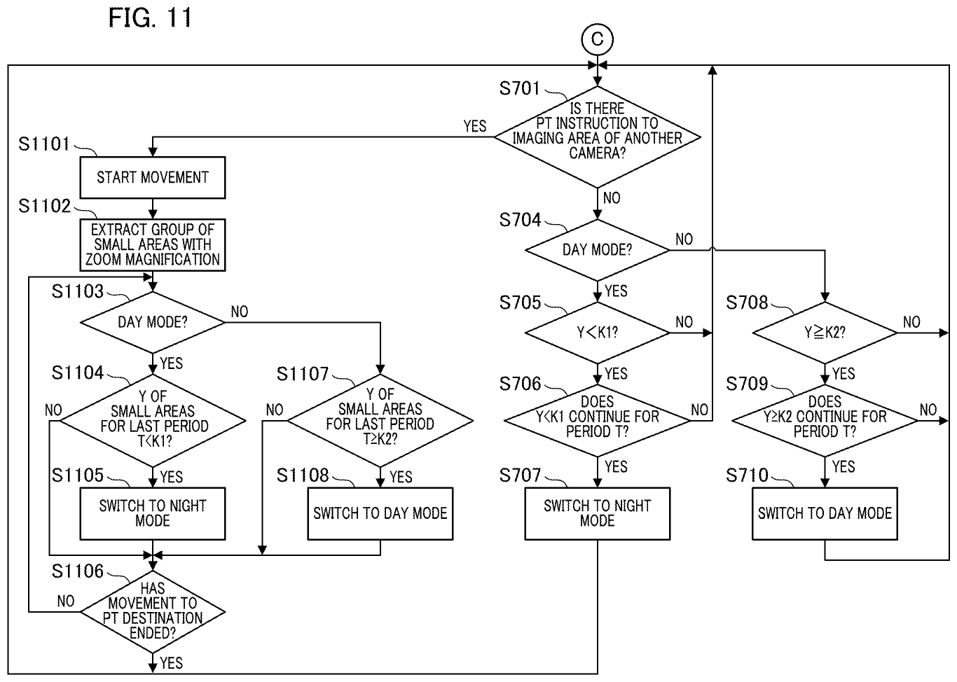

Next, an operation of switching between the day mode and the night mode of the camera 1400 that can change an imaging direction will be described using the flowchart of FIG. 11. FIG. 11 is a flowchart for describing an operation of switching between the day mode and the night mode of the camera 1400 according to the second embodiment. Each operation (step) shown in this flowchart can be executed by the signal processing unit 1500.

When power of the imaging device 1000 is on, the camera 1400 starts the operation of switching between the day mode and the night mode after a predetermined initialization process ends. First, the signal processing unit 1500 checks whether there is an instruction from an operator to change a pan angle and a tile angle of the camera 1400 to change the direction to the direction in which the remaining cameras 1100 to 1300 are performing imaging (S701). In other words, the signal processing unit 1500 checks whether there is an instruction to the camera 1400 from the operator to change the imaging area to an area overlapping the imaging area of the other cameras 1100 to 1300. If there is the instruction from the operator to change the direction to the area that the other cameras 1100 to 1300 are performing imaging (Yes), a change of the direction of the camera 1400 is started via the PT drive unit 14021 so that the camera 1400 faces the instructed direction (S1101).

Next, the signal processing unit 1500 extracts a group of small areas to be captured by the camera 1400 after the change of the imaging direction with the current zoom magnification of the camera 1400 and the instructed imaging direction change destination (S1102). At this time, the group of small areas may not completely match the area to be captured by the camera 1400 due to the zoom magnification. In that case, the group of small areas may be extracted to be one size larger or one size smaller than the area to be captured by the camera 1400. Further, depending on a specified imaging direction, the area to be captured by the camera 1400 may expand to the outside of the imaging area of the other cameras. In such a case, an overlapping area of the area to be captured by the camera 1400 and the area captured by the other cameras may be extracted as a group of small areas.

Next, the signal processing unit 1500 checks whether the imaging mode of the camera that will capture the area specified by the operator is the day mode or the night mode (S1103). If the imaging mode is the day mode (Yes) in S1103, the signal processing unit 1500 compares an average luminance value Y of the small areas extracted in S1102 for the last three seconds with a threshold value K1 at which the day mode is switched to the night mode (S1104). If the average luminance value Y is smaller than the threshold value K1 (Yes), that is, the video to be captured by the camera 1400 after the change of the imaging direction is dark enough to have a value smaller than a predetermined value, the mode is switched to the night mode (S1105).

Next, the signal processing unit 1500 determines whether the change of the camera direction of the camera 1400 to the instructed direction has been completed (S1106), and if the change of the direction is not completed (No), the process returns to S1103, and if the change of the direction is completed, the process returns to S701.

On the other hand, if the imaging mode is the night mode (No) in S1103, the signal processing unit 1500 compares the average luminance value Y of the small areas for the last three seconds extracted in S1102 with a threshold value K2 at which the night mode is switched to the day mode (S1107). If the average luminance value Y is equal to or higher than the threshold value K2 (Yes), that is, the video to be captured by the camera 1400 after the change of the imaging direction is bright having a value smaller than the predetermined value, the mode is switched to the day mode (S1108), and the process proceeds to S1106. If the average luminance value Y is smaller than the threshold value K2 (No) in S1107, the process proceeds to S1106. In FIG. 11, description is omitted due to S704 to S710 are the same as those in the first embodiment.

According to the present embodiment, because control of the day mode and the night mode is performed using image information of an image captured by the other cameras, control of the day mode and the night mode is possible in accordance with actual brightness of an imaging area. In addition, it is possible to flexibly deal with uneven brightness in the imaging area.

### Third Embodiment

In the first embodiment, a case in which the camera 1400 that can change an imaging direction of the camera is caused to face an imaging area of the other cameras 1100 to 1300 has been described. However, if a direction that the camera 1400 is facing is close to that of the other cameras 1100 to 1300, similar effects are obtained by adjusting to the imaging mode of the camera capturing a close area even though imaging areas do not overlap.

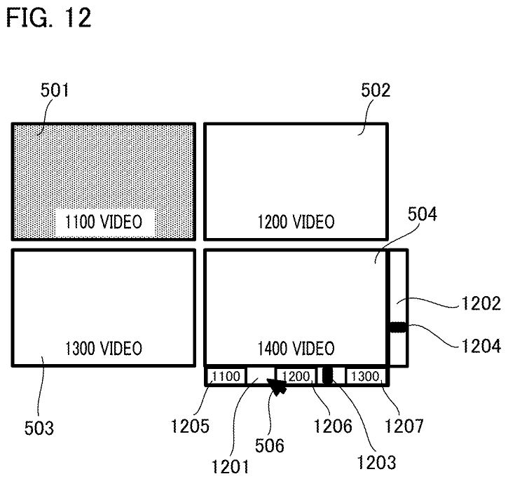

FIG. 12 is a diagram illustrating an example of a state in which videos are displayed on a display device according to a third embodiment. The same content as that of FIG. 5 will not be described. Bars 1201 and 1202 represent imaging directions of the camera 1400 with respect to the horizontal direction and the vertical direction of the imaging device 1000. Positions of sliders 1203 and 1204 represent current imaging directions of the camera 1400 in the horizontal direction and the vertical direction. Displays 1205, 1206, and 1207 represent imaging areas of the cameras 1101, 1200, and 1300 in the horizontal direction, respectively. When an operator moves the sliders 1203 and 1204 or clicks a predetermined position on the bars 1201 and 1202 using the pointer 506 operated with an input unit such as a mouse, an imaging direction of the camera 1400 can be changed. Further, although only the change of the imaging direction is displayed on the display screen, a zoom magnification may be similarly displayed and changed. For example, an operator clicks a position shown in FIG. 12 using the pointer 506 operated with the input unit such as a mouse. Then, the camera 1400 changes the imaging direction to a direction that is between the directions in which the cameras 1100 and 1200 are performing imaging and close to the imaging area of the camera 1200. At this time, a position specified by a user is closer to the imaging area of the camera 1200, and the distance between the imaging area of the camera 1400 after the change of the imaging direction and the imaging area of the camera 1200 becomes equal to or shorter than the threshold value. Thus, in this case, the imaging mode of the camera 1400 may be adjusted to the imaging mode of the camera 1200.

Further, in a case in which there are a plurality of cameras other than the camera 1400 as in the present embodiment, it is preferable to adjust an imaging mode to an imaging mode of a camera capturing an area that is the closest to the imaging area of the camera 1400 after the change of the imaging area.

In addition, control of switching between the day mode and the night mode may be performed based on, for example, image information of a partial area included in an imaging area of the cameras 1100, 1200, and 1300 that is an area in a distance to the imaging area of the camera 1400 after the change of the imaging direction being equal to or shorter than a threshold value. Specifically, as in the second embodiment, luminance information of a group of small areas in accordance with the current zoom magnification of the camera 1400 is used from an area in a distance to the imaging area of the camera 1400 after the change of the imaging direction being equal to or shorter than the threshold value. In addition, at this time, image information of a camera capturing an area that is closest to the imaging area of the camera 1400 after the change of the imaging area is preferably used.

According to the present embodiment, even if an imaging area of the camera 1400 is changed to an area that is not captured by any other camera, control of the day mode and the night mode reflecting brightness of the imaging area in real time is possible.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Although a case of a combination of multi-lens cameras with a PTZ camera has been described in the above embodiments, the cameras included in the imaging device are not required to be movable on the guide unit, and for example, a combination of cameras fixedly disposed at equal intervals on the circumference of the imaging device with a PTZ camera is possible.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e. g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

This application claims the benefit of Japanese Patent Application No. 2020-49678, filed Mar. 19, 2020, which is hereby incorporated by reference wherein in its entirety.

What is claimed is:

1. An imaging device comprising:
a first imaging unit that has a first infrared cut filter and configured to change an imaging area;
a second imaging unit that has a second infrared cut filter;
an insertion/removal unit configured to insert or remove the first infrared cut filter and the second infrared cut filter into or from each of optical paths of the first imaging unit and the second imaging unit; and
a control unit configured to control insertion or removal of the first infrared cut filter based on image information of the second imaging unit in a case where the imaging area of the first imaging unit is changed so as to overlap with an imaging area that the second imaging unit is capturing or changed to an area close to the imaging area that the second imaging unit is capturing from a state in which the imaging area of the first image unit does not overlap the imaging area of the second imaging unit.

2. The imaging device according to claim 1, wherein the control unit starts the control of insertion or removal until the change of the imaging area of the first imaging unit ends.

3. The imaging device according to claim 1, wherein the control unit controls the insertion or removal based on image information of the entire imaging area that the second imaging unit is capturing.

4. The imaging device according to claim 1, wherein the control unit controls the insertion or removal based on image information of an area around a specified area in a case where the imaging area of the first imaging unit is changed so as to overlap with the imaging area that the second imaging unit is capturing.

5. The imaging device according to claim 1, wherein, in a case where the imaging area of the first imaging unit is changed to an area close to the imaging area that the second imaging unit is capturing, the control unit controls the insertion or removal based on image information of the imaging area that the second imaging unit is capturing, the imaging area in a distance to the imaging area of the first imaging unit after the change being equal to or shorter than a threshold value.

6. The imaging device according to claim 1, wherein the image information includes luminance information.

7. The imaging device according to claim 1, further comprising:
a plurality of illumination units,
wherein the control unit controls turning-on of the illumination units in accordance with the control of insertion or removal of at least one of the first infrared cut filter and the second infrared cut filter.

8. The imaging device according to claim 1, wherein the second imaging unit is movable along a circular guide unit.

9. An imaging device comprising:
a first imaging unit that has a first infrared cut filter and configured to change an imaging area;
a second imaging unit that has a second infrared cut filter;
an insertion/removal unit configured to insert or remove the first infrared cut filter and the second infrared cut filter into or from each of optical paths of the first imaging unit and the second imaging unit; and
a control unit configured to control insertion or removal of the first infrared cut filter based on an insertion or removal state of the second infrared cut filter in a case where the imaging area of the first imaging unit is changed so as to overlap with an imaging area that the second imaging unit is capturing from a state in which the imaging area of the first image unit does not overlap the imaging area of the second imaging unit.

10. The imaging device according to claim 9, wherein the control unit starts the control of insertion or removal until the change of the imaging area of the first imaging unit ends.

11. The imaging device according to claim 9, comprising:
a plurality of illumination units,
wherein the control unit performs control such that the illumination units turn on according to the control of insertion or removal of at least one of the first infrared cut filter and the second infrared cut filter.

12. The imaging device according to claim 9, wherein the second imaging unit is movable along a circular guide unit.

13. A control method of an imaging device including a first imaging unit that has a first infrared cut filter and configured to change an imaging area, a second imaging unit that has a second infrared cut filter, and an insertion/removal unit configured to insert or remove the first infrared cut filter and the second infrared cut filter into or from each of optical paths of the first imaging unit and the second imaging unit,
wherein insertion or removal of the first infrared cut filter of the first imaging unit is switched based on image information of the second imaging unit in a case where the imaging area of the first imaging unit is changed so as to overlap with an imaging area that the second imaging unit is capturing or changed to an area close to the imaging area that the second imaging unit is capturing from a state in which the imaging area of the first imaging unit does not overlap the imaging area of the second imaging unit.

14. A non-transitory computer-readable storage medium storing a program for causing a computer to execute a control method of an imaging device including a first imaging unit that has a first infrared cut filter and configured to change an imaging area, a second imaging unit that has a second infrared cut filter, and an insertion/removal unit configured to insert or remove the first infrared cut filter and the second infrared cut filter into or from each of optical paths of the first imaging unit and the second imaging unit,
wherein the control method includes switching to insertion or removal of the first infrared cut filter of the first imaging unit based on image information of the second imaging unit in a case where the imaging area of the first imaging unit is changed so as to overlap with an imaging area that the second imaging unit is capturing or changed to an area close to the imaging area that the second imaging unit is capturing from a state in which the imaging area of the first imaging unit does not overlap the imaging area of the second imaging unit.
